(19) United States
(12) Patent Application Publication
(10) Pub. No.: US 2004/0238545 A1
(43) Pub. Date: Dec. 2, 2004

(54) Method for making a tank containing compressed gas and resulting tank

(76) Inventor: Gerard Goffre, Laloubere (FR)

Correspondence Address: PARKHURST & WENDEL, L.L.P., 1421 PRINCE STREET, SUITE 210, ALEXANDRIA, VA, 22314-2805, US

(21) Appl. No.: 10/484,870

(22) PCT Filed: Jul. 31, 2002
(86) PCT No.: PCT/FR02/02751

(30) Foreign Application Priority Data
Jul. 31, 2001 (FR) 0110222
Aug. 30, 2001 (FR) 01/11274

(51) Int. Cl. F17C 1/00

(52) U.S. Cl. 220/581

(57) ABSTRACT

The invention relates to a manufacturing process for a compressed gas tank, for example natural gas intended for a motor vehicle, of the type incorporating a metallic inner envelope 1 and an outer envelope 8 of a composite material.

The metallic envelope 1 is made from stainless steel sheets comprising a cylindrical trunk 2 and two hemispherical or elliptical end caps 3, 4 welded together and in that an outer envelope 8 is made around said inner envelope by filament winding of a composite material. The inner envelope 1 has a thickness of around a mm. The filament winding is made using carbon filament that may be associated with other fibres, impregnated with an epoxy type resin.

Application to CNG tanks for vehicles.

The technical scope of the present invention is that of tanks intended to contain compressed gas, for example natural gas to equip motor vehicles.

Gas-operated vehicles are becoming more and more common throughout the world and tanks enclosing liquefied petroleum gas (LPG) and tanks enclosing compressed natural gas (CNG) are known. The natural gas is generally methane. The liquefied petroleum gas is generally at a pressure of 30.10⁵ Pa and the natural gas is compressed at a pressure of around 300.10⁵ Pa. The technologies used in these two types of tank are not the same.

Many types of CNG tanks have been proposed. These tanks are designed to withstand very high pressure and, more often than not, are metallic.

Thus, patent U.S. Pat. No. 5,443,578 proposes a steel metallic tank. It is well known that these tanks, although pressure resistant, are very heavy, at around 100 kg for a volume of 100 litres. This mass requires their installation on a powerful private car to be specially studied since their assembly imposes the reinforcement of the car's structure. This reduces the number of passengers and the payload and can disturb the way the vehicle holds the road. However, this type of tank is competitive from a financial point of view. This tank may not be employed on private cars without some form of alteration to the car.

Patent WO09851962 proposes to improve this type of tank by providing a tank comprising a sufficiently resistant inner envelope and a honeycombed outer envelope. This tank is disadvantaged by its bulk.

Document DE-19935516 describes a tank constituted by a metallic inner envelope and a fibre-reinforced outer envelope. The manufacture of this tank is not specified in practical terms. We know that this type of tank may be made from monoblock aluminium liners obtained by flow-turning and/or planishing, which are expensive.

Patent WO9412396 describes a tank whose inner envelope is constituted by a polymer and whose outer envelope is constituted by a matrix of non-metallic fibres impregnated with thermohardened resin. This tank has the drawback of not being completely gastight and being expensive but offers the advantage of being of reduced mass.

The aim of the present invention is to provide a process allowing a tank to be made to contain compressed gas that makes a compromise between its mass and a cost that is acceptable from an economic point of view on a powerful private car.

The invention thus relates to a manufacturing process for a compressed gas tank, for example natural gas intended for a motor vehicle, of the type incorporating a metallic inner envelope and an outer envelope of a composite material, wherein the metallic envelope is made from stainless steel sheets comprising a cylindrical trunk and two hemispherical end caps welded together and in that an outer envelope is made around said inner envelope by filament winding of a composite material.

By motor vehicle we mean any type of vehicle operating with this kind of fuel, such as private or utility vehicles, buses, lorries, plant, etc.

According to one characteristic of the invention, the inner envelope has a thickness of around a mm.

According to another characteristic of the invention, the filament winding is made using a carbon filament impregnated with an epoxy type resin, and may be combined with filaments of a different kind.

According to another characteristic of the invention, at least one threaded end piece, and more particularly two, is welded to the base of the hemispherical or elliptical caps.

According to another characteristic of the invention, carbon filament having a diameter of less than a mm is used.

The invention also relates to a tank for a vehicle operating on compressed natural gas obtained according to the process.

Advantageously, the tank has an inner diameter of around 350 mm and a length of 1400 mm.

A first advantage of the process according to the invention lies in the fact that the manufacture of the tank only requires the implementation of classical technologies for the welding and filament winding operations.

Another advantage lies in the fact that the manufactured tank may be incorporated into a vehicle without requiring said vehicle to be specifically modified.

Other characteristics, particulars and advantages of the invention will become more apparent from the description given hereafter by way of illustration and in reference to the appended drawings, in which:

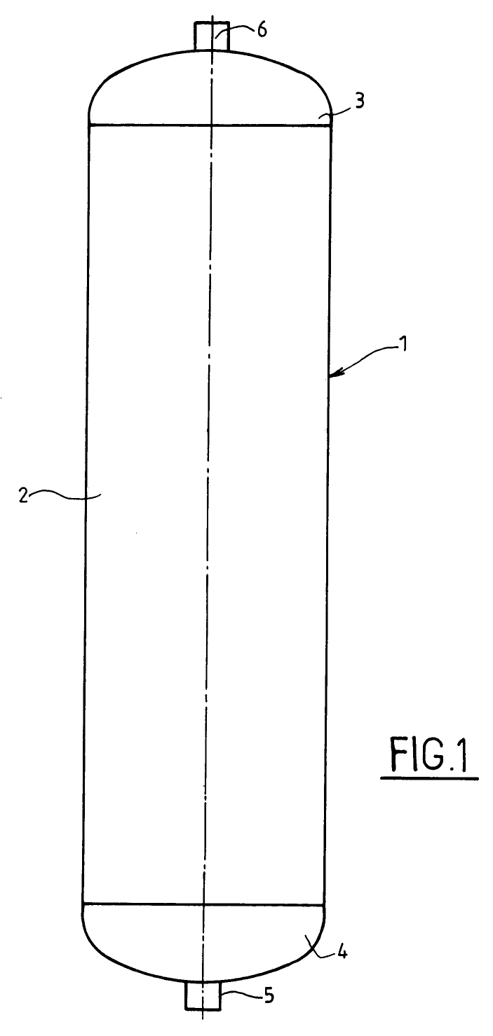

FIG. 1 is an outer view of the metallic envelope, and

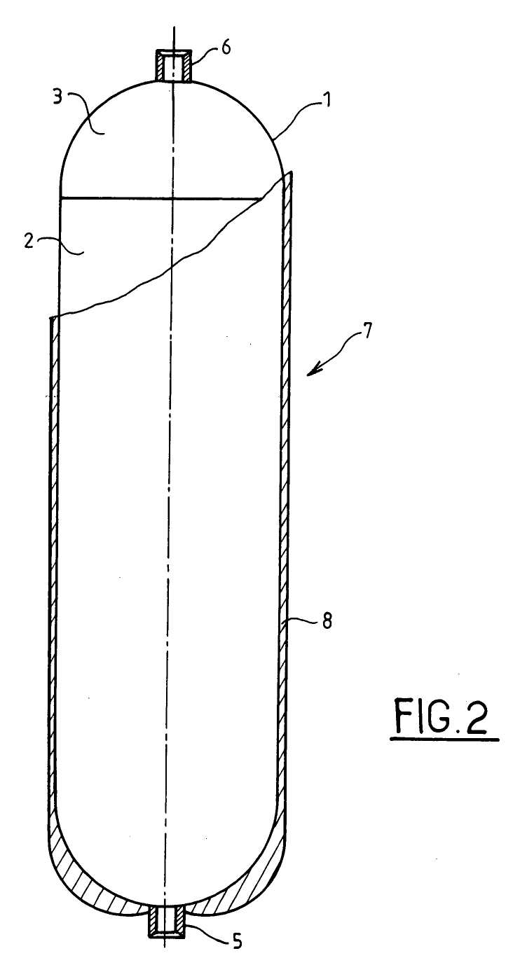

FIG. 2 is a section of the tank.

FIG. 1 shows the liner 1 of a tank, that is to say the inner metallic envelope mainly ensuring gastightness. This liner 1 comprises a trunk 2 that is globally cylindrical in shape and two hemispherical caps 3 and 4, these three elements being made of stainless steel. The trunk 2 is made from a sheet of stainless steel of a thickness of around a mm that is welded edge to edge longitudinally. Caps 3 and 4 are identical and are made by drawing a sheet of stainless steel of a thickness of around a mm. The two caps 3 and 4 are then welded onto the trunk 2. The caps are fitted with ends 5 and 6 that can be threaded. These ends 5 and 6 firstly allow the liner 2 to be fastened onto the winding apparatus and secondly allow the tank to be integrated into a vehicle. One of the ends may be hollow so as to communicate with the inside of the body so as to enable replenishment and supply to the vehicle.

We see here the full advantage of the liner made according to the invention. It only uses classical drawing and welding processes that require no special adaptation of the industrial tooling. This liner procures a reduction in mass and an increase in useful volume with respect to a steel liner. Lastly, this liner is of a very affordable cost.

FIG. 2 shows a tank 7 constituted by the liner 1 and an outer envelope 8. This envelope 8 is made as explained previously by coiling a carbon filament impregnated with a resin, for example an epoxy resin. The carbon filament may be associated with fibres of another kind. The coiling operation is classical in itself and does not requires further explanation. The tank 7 is fastened onto the coiling machine, which is classically programmed so carry out suitable winding of the filament around the liner both over the body 2 and the caps 5 and 6. The carbon filament is a filament of a known type having the classical characteristics of filament winding. The Figure shows that the envelope 8 is closely linked to the inner envelope and presses on the ends. Such an arrangement guarantees that the tank is able to withstand an inner compressed gas service pressure of over 200.10⁵ Pa. The filament used is preferably carbon, but it is possible for a filament of another kind to be used, for example a metallic, mineral or synthetic filament.

For a tank having an inner diameter of around 350 mm and a length of 1400 mm, the mass is of around 40 kg.

The tank according to the invention may be used not only to supply vehicles with natural gas, but may also enclose compressed air, hydrogen or any other gas in compressed form.

1. A manufacturing process for a compressed gas tank (7), for example natural gas intended for a motor vehicle, of the type incorporating a metallic inner envelope (1) and an outer envelope (8) of a composite material, wherein the metallic envelope (1) is made from stainless steel sheets comprising a cylindrical trunk (2) and two hemispherical end caps (3, 4) welded together and in that an outer envelope (8) is made around said inner envelope by filament winding of a composite material.

2. A manufacturing process according to claim 1, wherein the inner envelope has a thickness of around a mm.

3. A manufacturing process according to claim 1, wherein the filament winding constituting the outer envelope (8) is made using a carbon filament impregnated with an epoxy type resin, and may be combined with filaments of a different kind.

4. A manufacturing process according to claim 1, wherein at least one threaded end piece (5, 6) is welded to the base of the caps (3, 4).

5. A manufacturing process according to claim 4, wherein two end pieces (5, 6) are employed.

6. A manufacturing process according to claim 4, wherein a carbon filament having a diameter of less than a mm is used.

7. A manufacturing process according to claim 1, wherein the caps (3, 4) are hemispherical or elliptical in shape.

8. A tank for a vehicle operating on compressed natural gas obtained according to the process in accordance with claim 1.

9. A tank according to claim 8, wherein it has an inner diameter of around 350 mm and a length of 1400 mm.
